(19) United States
(12) Patent Application Publication
(10) Pub. No.: US 2016/0054503 A1
(43) Pub. Date: Feb. 25, 2016

(54) Backlight Module and Liquid Crystal Display Device

(71) Applicant: Shenzhen China Star Optoelectronics Technology Co. Ltd., Shenzhen, Guangdong (CN)

(72) Inventor: Yong Fan, Shenzhen (CN)

(73) Assignee: Shenzhen China Star Optoelectronics Technology Co. Ltd., Shenzhen, Guangdong (CN)

(21) Appl. No.: 14/384,150

(22) PCT Filed: Aug. 22, 2014
(86) PCT No.: PCT/CN2014/085039

§ 371 Date: Sep. 9, 2014

(30) Foreign Application Priority Data
Aug. 19, 2014 (CN) 201410413409.6

(51) Int. Cl. F21V 8/00

(52) U.S. Cl. CPC G02B 6/0026

(57) ABSTRACT

The present invention discloses a backlight module, comprising: a light guide plate, which comprises at least one light incident side; a light source, which is provided adjacent to the light incident side; and at least one quantum dot film strip, which is provided between the light source and the light incident side; wherein, the light emitted from the light source is irradiated to the light incident side through the quantum dot film strip. The present invention further discloses a liquid crystal display device having the backlight module.

### BACKGROUND OF THE INVENTION

1. Field of the Invention

The present invention relates to the fields of liquid crystal display technology, and in particular to a backlight module and a liquid crystal display device.

2. The Related Arts

In the existing liquid crystal display device, the white light emitting diode (LED) is usually used as backlight source, which provides the desired backlight through using guide light plate and optical membrane reasonably. With higher demand of human for high color gamut, high color saturation and energy saving, the suggestion of the existing backlights having white light source, high color gamut and high color saturation comprise: UV LED with RGB phosphors; blue LED with red and green phosphors; blue LED with green LED and red LED. These programs can improve the color gamut, but they are difficult to realize and have higher costs.

Quantum dot (QD) technology is a technology to tie electrons within a certain range of nano semiconductor material structure, which is consisted of ultra-small crystals with sizes of 1˜100 nm. In the quantum dot technology, by using the crystals with different sizes to control the wavelength of light, and then control the light color. Therefore, the quantum dot material applied in the backlight module utilizes high frequency blue light emitting diode replaces the traditional white LED source. The quantum dot can generate lights with different wavelength under the irradiation of the high frequency light source. By adjusting the sizes of the quantum dot material, it can adjust the color of the synthesized light and achieve the demands of high color gamut of the backlight of the liquid crystal display device.

FIG. 1 is a backlight module using quantum dot phosphormembrane according to the existing technology. Referring to FIG. 1, the blue light emitting diode 11 is provided at the light incident side of the light guide plate 12, and the quantum dot phosphor membrane 13 is provided on the light incident side of the light guide plate 12. Wherein, the light emitted from the blue LED 11 is transformed to surface light by the light guide plate 12 and then emitted from the light exit side of the light guide plate 12 through the quantum dot phosphor membrane 13, so that the blue light is transformed to the required backlight of the liquid crystal display device. However, in the large-size liquid crystal display device, the quantum dot phosphor membrane 13 should be produced in large area, which requires more quantum dot material. Moreover, the spraying of the quantum dot phosphor layer requires higher uniformity, leading to high costs. In addition, when using the quantum dot phosphor membrane 13, if the optical membrane architectures are different or optical membrane models are different, the chrominance and luminance will vary significantly after the improved light by the optical membrane irradiates through the liquid crystal display panel. Therefore, during using the quantum dot phosphor membrane 13, the architecture, the supplier or the model of the optical membrane can not be changed, which greatly limits the flexibility and universality of the quantum dot phosphors used in optical membrane.

FIG. 2 is another backlight module using quantum dot phosphormembrane according to the existing technology. Referring to FIG. 2, the blue LED 21 is provided at the light incident side of the light guide plate 22, and the quantum dot phosphor is encapsulated inglass tube to form a quantum dot phosphor glass tube 23. Wherein, the quantum dot phosphor glass tube 23 is provided between the blue LED 21 and the light incident side of the light guide plate 12. The light emitted from the blue LED 21 is irradiated to the light incident side of the light guide plate 12 through the quantum dot phosphor glass tube 23. However, when using this method, the quantum dot phosphor glass tube 23 is complex to produce and has higher costs, and the quantum dot phosphor glass tube 23 is easily broken.

### SUMMARY OF THE INVENTION

In order to solve the above technical issue, the object of the present invention is to provide a backlight module, comprising: a light guide plate, which comprises at least one light incident side; a light source, which is provided adjacent to the light incident side; and at least one quantum dot film strip, which is provided between the light source and the light incident side; wherein, the light emitted from the light source is irradiated to the light incident side through the quantum dot film strip.

Furthermore, the quantum dot film strip comprises a quantum dot phosphor layer and a transparent protective outer layer; wherein, the transparent protective outer layer encapsulates the quantum dot phosphor layer.

Furthermore, the quantum dot film strip further comprises a vapor isolation layer, which is provided between the transparent protective outer layer and the quantum dot phosphor layer.

Furthermore, the backlight module further comprises a condensing unit, which is provided between the quantum dot film strip and the light incident side.

Furthermore, the backlight module further comprises a condensing unit, which is provided on the outer side of the transparent protective outer layer.

Furthermore, the transparent protective outer layer is made of polyethylene terephthalate.

Furthermore, the quantum dot phosphor layer is formed by inkjet printing.

Furthermore, the vapor isolation layer is made of silicone.

The another object of the present invention is to provide liquid crystal display device, which comprises a backlight module and a liquid crystal display panel provided oppositely; wherein, the backlight module provides display light for the liquid crystal display panel, and then the liquid crystal display panel displays images; wherein, the backlight module is the backlight module mentioned above.

The backlight module and the liquid crystal display device according to the present invention utilizes a quantum dot film strip prepared by optical thin film encapsulation, which has smaller light coupling distance and improves the light coupling efficiency. Moreover, it utilizes a prism structure to concentrate the light through the quantum dot film strip, which reduces the angle of the light irradiated to the light incident side of the light guide plate and further improves the light coupling efficiency. Furthermore, the quantum dot film strip is formed by printing, which is easy to prepare without size restrictions, reduces the usage of the quantum dot phosphor, and then decreases the costs. In addition, the quantum dot film strip is easy to splice without the broken problems.

### BRIEF DESCRIPTION OF THE DRAWINGS

Through the detailed descriptions accompanying drawings as follows, other aspects, features, and advantages of the embodiment of the present invention will become clearer.

FIG. 1 is a backlight module using quantum dot phosphormembrane according to the existing technology;

FIG. 2 is another backlight module using quantum dot phosphormembrane according to the existing technology;

FIG. 3 is a schematic structural diagram of the liquid crystal display device according to an embodiment of the present invention;

FIG. 4 is a schematic structural diagram of the backlight module according to a first embodiment of the present invention;

FIG. 5 is a schematic structural diagram of the quantum dot film strip according to a first embodiment of the present invention;

FIG. 6 is a schematic structural diagram of the backlight module according to a second embodiment of the present invention;

FIG. 7 is a schematic structural diagram of the backlight module according to a third embodiment of the present invention;

FIG. 8 is a schematic structural diagram of the quantum dot film strip according to a third embodiment of the present invention; and

FIG. 9 is a schematic structural diagram of the backlight module according to a fourth embodiment of the present invention.

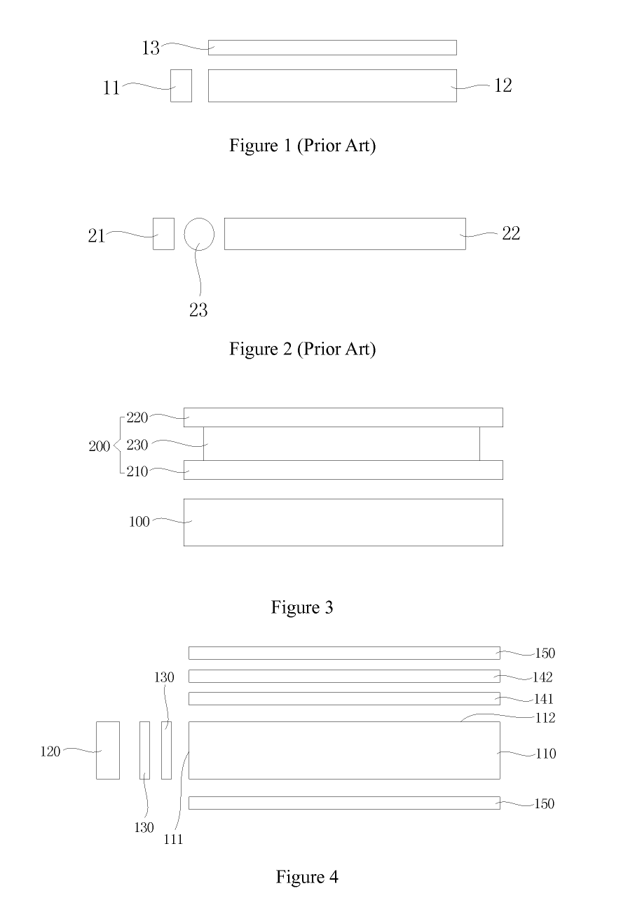

### DETAILED DESCRIPTION OF THE PREFERRED EMBODIMENTS

The detailed descriptions according to the preferred embodiment of the present invention are as follows. However, the present invention can be carried out in many different forms, which should not be construed as limited to the specific embodiments set forth herein. On the contrary, these embodiments are provided to explain the principles of the present invention and the practical applications thereof, so that those having ordinary skills in the art can understand various embodiments in the present invention and various modifications suited to the particular intended application.

It will be understood that, although the term “first”, “second”, and so on may be used herein to describe various units, these units should not be limited by these terms. These terms are only used to distinguish one element from another.

FIG. 3 is a schematic structural diagram of the liquid crystal display device according to an embodiment of the present invention.

Referring to FIG. 3, the liquid crystal display device according to the embodiment of the present invention comprises a liquid crystal display panel 200 and a backlight module 100 opposite to the liquid crystal display panel 200. Wherein, the backlight module 100 provides display light for the liquid crystal display panel 200, and then the liquid crystal display panel 200 displays images.

The liquid crystal display panel 200 usually comprises a thin film transistor (TFT) array substrate 210, a color filter (CF) substrate 220 provided opposite to the TFT array substrate 210, and a liquid crystal 230 provided between the TFT array substrate 210 and the CF substrate 220. Wherein, the liquid crystal 230 comprises several liquid molecules. Because the specific structure of the liquid crystal display panel 200 according to the present embodiment is similar to the liquid crystal display panel according to the existing technology, it is not repeated here.

The specific configuration of the backlight module 100 according to the embodiment of the present invention will be described in detail as follows.

### First Embodiment

FIG. 4 is a schematic structural diagram of the backlight module according to the first embodiment of the present invention.

Referring to FIG. 4, the backlight module 100 according to the first embodiment of the present invention comprises: a light guide plate 110, a light source 120, two quantum dot film strips 130, a first brightening membrane 141, a second brightening membrane 142, a diffusion film 150 and a reflective sheet 160.

Specifically, the light guide plate 110 comprises a light incident side 111 and a light exit side 112. The light source 120 is provided adjacent to the light incident side 111 of the light guide plate 110. Two quantum dot film strips 130 are both provided between the light source 120 and the light incident side 111 of the light guide plate 110. Wherein, the light emitted from the light source 120 is irradiated to the light incident side 111 of the light guide plate 110 through the two quantum dot film strips 130. The first brightening membrane 141, the second brightening membrane 142 and the diffusion film 150 are sequentially provided on the light exit side 112 of the light guide plate 110. Wherein, the first brightening membrane 141 and the second brightening membrane 142 are used to concentrate the light emitted from the light exit side 112, which increases the brightness of the light emitted from the light exit side 112; the diffusion film 150 is used to increase the upward brightness of the light irradiated through the first brightening membrane 141 and the second brightening membrane 142 and soften the light irradiated through the first brightening membrane 141 and the second brightening membrane 142, which provides uniform surface light source for the liquid crystal display panel 200. The reflective sheet 160 is provided under the light guide plate 110, which is used to reflect the light emitted from the bottom of the light guide plate 110 back to the light guide plate 110, to increase the utilization of light in the light guide plate 110.

In the present embodiment, the light source 120 can be LED strip assembled by multiple high frequency blue light emitting diodes, but the present invention is not restricted herein. The high frequency blue light emitting diodes irradiate the quantum dot materials in the two quantum dot film strips 130, so that the quantum dot materials will generate light with various colors and provide the white backlight for the liquid crystal display device.

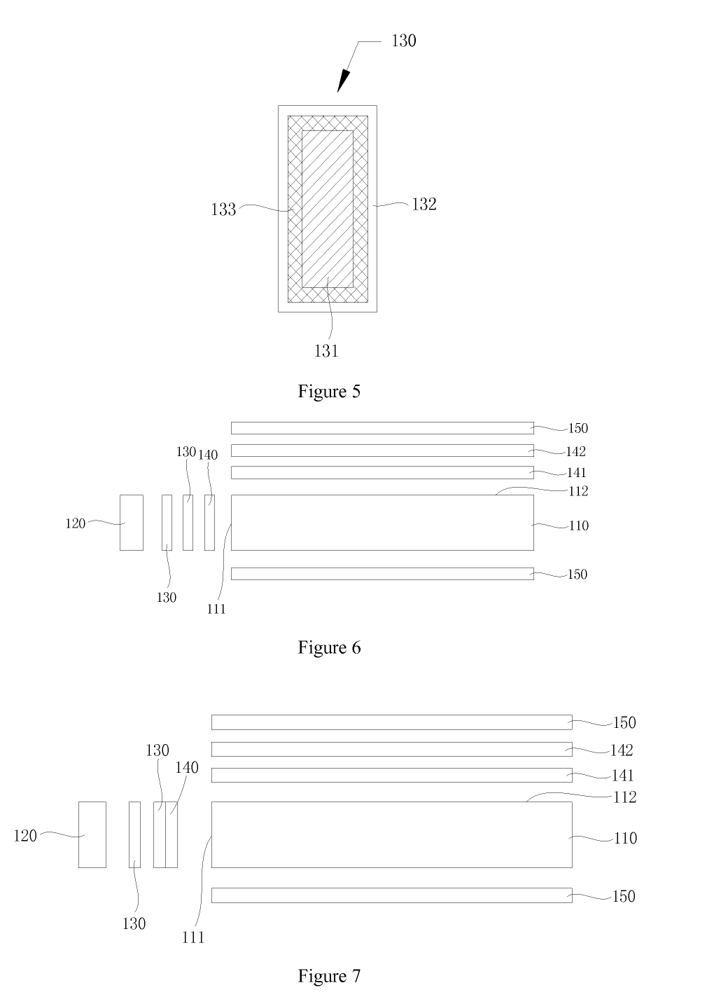

FIG. 5 is a schematic structural diagram of the quantum dot film strip according to the first embodiment of the present invention.

Referring to FIG. 5, the quantum dot film strip 130 according to the first embodiment of the present invention comprises a quantum dot phosphor layer 131 and a transparent protective outer layer 132. Wherein, the transparent protective outer layer 132 encapsulates the quantum dot phosphor layer 131. It should be noted that the amount of the quantum dot film strip 130 is not limited the number shown in FIG. 4, which can be one, three, and so on. Moreover, the quantum dot phosphor layer 131 is formed by inkjet printing, but the present invention is not limited thereto.

In the present embodiment, the transparent protective outer layer 132 is made of polyethylene terephthalate (PET), but the present invention is not limited thereto. The transparent protective outer layer 132 can also be made of other suitable transparent materials. In addition, in order to prevent the quantum dot phosphor layer 131 exposed to moisture, the quantum dot film strip 130 according to the first embodiment of the present invention further comprises a vapor isolation layer 133, which is provided between the transparent protective outer layer 132 and the quantum dot phosphor layer 131, which prevents the water vapor in the environment entering and prolongs the life time of the quantum dot phosphor layer 131. In the present embodiment, the thickness of the vapor isolation layer 133 is about 200 μm, which is made of silicone, but the present invention is not limited thereto.

In the present embodiment, the width of the quantum dot phosphor layer 131 is 0.5 mm-10 mm, and the thickness thereof is 0.2 mm-1.5 mm, but the present invention is not limited thereto.

### Second Embodiment

FIG. 6 is a schematic structural diagram of the backlight module according to a second embodiment of the present invention.

In the description of the second embodiment, the parts similar to the first embodiment is not repeated here, only the parts differs from the first embodiment will be described. Referring to FIG. 6, the difference between the second embodiment and the first embodiment is that the backlight module 100 according to the second embodiment of the present invention further comprises a condensing unit 140. Wherein, the condensing unit 140 is provided between the quantum dot film strip 130 and the light incident side 111. Moreover, in the other embodiment, the condensing unit 140 is provided between the two quantum dot film strips 130. The condensing unit 140 can condense the light through the two quantum dot film strips 130, which reduces the angle of the light irradiated to the light incident side 111 of the light guide plate 110 and further improves the light coupling efficiency.

In the present embodiment, the condensing unit 140 can be prism sheet, but the present invention is not limited thereto. The light exit side of the prism sheet is the same as that of the light source 120, and the prism ridge direction of the prism sheet is parallel with the long direction of the light source 120 (LED string).

### Third Embodiment

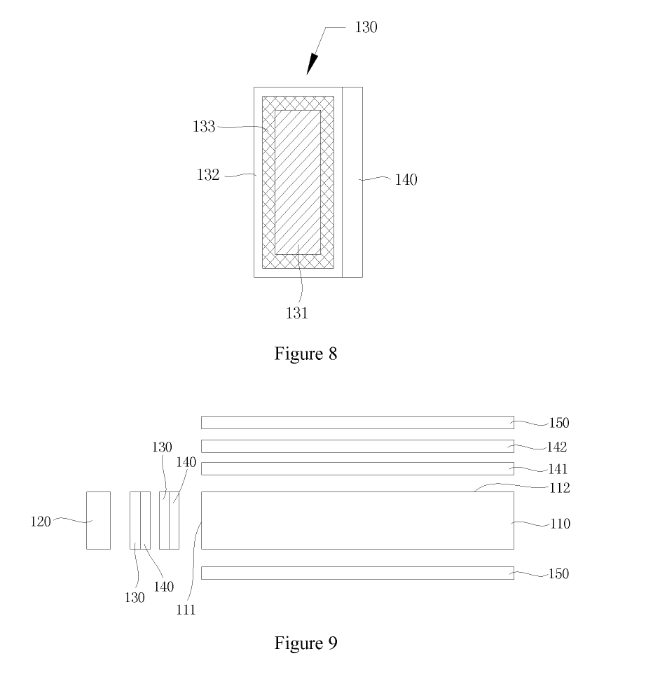

FIG. 7 is a schematic structural diagram of the backlight module according to the third embodiment of the present invention. FIG. 8 is a schematic structural diagram of the quantum dot film strip according to the third embodiment of the present invention.

In the description of the third embodiment, the parts similar to the first embodiment is not repeated here, only the parts differs from the first embodiment will be described. Referring to FIG. 7, the difference between the third embodiment and the first embodiment is that the backlight module 100 according to the second embodiment of the present invention further comprises a condensing unit 140. Wherein, the condensing unit 140 is provided on the outer side of the transparent protective outer layer 132 of the quantum dot film strip 130 adjacent to the light incident side 111 of the light guide plate 110 in the two quantum dot film strips 130. In the other embodiment, the condensing unit 140 is provided on the outer side of the transparent protective outer layer 132 of the quantum dot film strip 130 adjacent to the light source 120 in the two quantum dot film strips 130.

In other words, the quantum dot film strip 130 according to the third embodiment of the present invention comprises the quantum dot phosphor layer 131, the transparent protective outer layer 132 and the condensing unit 140 provided on the outer side of the transparent protective outer layer. Wherein, the transparent protective outer layer 132 encapsulates the quantum dot phosphor layer 131. The condensing unit 140 can condense the light through the two quantum dot film strips 130, which reduces the angle of the light irradiated to the light incident side 111 of the light guide plate 110 and further improves the light coupling efficiency.

In the present embodiment, the transparent protective outer layer 132 is made of polyethylene terephthalate (PET), but the present invention is not limited thereto. The transparent protective outer layer 132 can also be made of other suitable transparent materials. In addition, in order to prevent the quantum dot phosphor layer 131 exposed to moisture, the quantum dot film strip 130 according to the first embodiment of the present invention further comprises a vapor isolation layer 133, which is provided between the transparent protective outer layer 132 and the quantum dot phosphor layer 131, which prevents the water vapor in the environment entering and prolongs the life time of the quantum dot phosphor layer 131. In the present embodiment, the thickness of the vapor isolation layer 133 is about 200 μm, which is made of silicone, but the present invention is not limited thereto.

In the present embodiment, the width of the quantum dot phosphor layer 131 is 0.5 mm-10 mm, and the thickness thereof is 0.2 mm-1.5 mm, but the present invention is not limited thereto.

In the present embodiment, the condensing unit 140 can be prism sheet, but the present invention is not limited thereto. The light exit side of the prism sheet is the same as that of the light source 120, and the prism ridge direction of the prism sheet is parallel with the long direction of the light source 120 (LED string).

### Third Embodiment

FIG. 9 is a schematic structural diagram of the backlight module according to the fourth embodiment of the present invention.

In the description of the fourth embodiment, the parts similar to the third embodiment is not repeated here, only the parts differs from the third embodiment will be described. Referring to FIG. 9, the difference between the fourth embodiment and the third embodiment is that the backlight module 100 according to the fourth embodiment of the present invention further comprises two condensing units 140. Wherein, each condensing unit 140 is provided on the outer side of the transparent protective outer layer 132 corresponding to the quantum dot film strip 130.

Each condensing unit 140 can condense the light through the corresponding quantum dot film strip 130, which reduces the angle of the light irradiated to the light incident side 111 of the light guide plate 110 and further improves the light coupling efficiency. In the present embodiment, the condensing unit 140 can be prism sheet, but the present invention is not limited thereto. The light exit side of the prism sheet is the same as that of the light source 120, and the prism ridge direction of the prism sheet is parallel with the long direction of the light source 120 (LED string).

In summary, the backlight module and the liquid crystal display device according to the present invention utilizes a quantum dot film strip prepared by optical thin film encapsulation, which has smaller light coupling distance and improves the light coupling efficiency. Moreover, it utilizes a prism structure to concentrate the light through the quantum dot film strip, which reduces the angle of the light irradiated to the light incident side of the light guide plate and further improves the light coupling efficiency. Furthermore, the quantum dot film strip is formed by printing, which is easy to prepare without size restrictions, reduces the usage of the quantum dot phosphor, and then decreases the costs. In addition, the quantum dot film strip is easy to splice without the broken problems.

The present invention are mentioned above referring to the specific embodiments, but for those having ordinary skills in the art, those modifications and variations are considered encompassed in the scope of protection defined by the clams of the present invention.

What is claimed is:

1. A backlight module, comprising:
a light guide plate, which comprises at least one light incident side;
a light source, which is provided adjacent to the light incident side; and
at least one quantum dot film strip, which is provided between the light source and the light incident side;
wherein, the light emitted from the light source is irradiated to the light incident side through the quantum dot film strip.

2. The backlight module as claimed in claim 1, wherein the quantum dot film strip comprises a quantum dot phosphor layer and a transparent protective outer layer; wherein, the transparent protective outer layer encapsulates the quantum dot phosphor layer.

3. The backlight module as claimed in claim 2, wherein the quantum dot film strip further comprises a vapor isolation layer, which is provided between the transparent protective outer layer and the quantum dot phosphor layer.

4. The backlight module as claimed in claim 1, wherein it further comprises a condensing unit, which is provided between the quantum dot film strip and the light incident side.

5. The backlight module as claimed in claim 2, wherein it further comprises a condensing unit, which is provided between the quantum dot film strip and the light incident side.

6. The backlight module as claimed in claim 2, wherein it further comprises a condensing unit, which is provided on the outer side of the transparent protective outer layer.

7. The backlight module as claimed in claim 3, wherein it further comprises a condensing unit, which is provided on the outer side of the transparent protective outer layer.

8. The backlight module as claimed in claim 2, wherein the transparent protective outer layer is made of polyethylene terephthalate.

9. The backlight module as claimed in claim 1, wherein the quantum dot phosphor layer is formed by inkjet printing.

10. The backlight module as claimed in claim 2, wherein the vapor isolation layer is made of silicone.

11. A liquid crystal display device, which comprises a backlight module and a liquid crystal display panel provided oppositely; wherein, the backlight module provides display light for the liquid crystal display panel, and then the liquid crystal display panel displays images; wherein, the backlight module comprises:
a light guide plate, which comprises at least one light incident side;
a light source, which is provided adjacent to the light incident side; and
at least one quantum dot film strip, which is provided between the light source and the light incident side;
wherein, the light emitted from the light source is irradiated to the light incident side through the quantum dot film strip.

12. The liquid crystal display device as claimed in claim 11, wherein the quantum dot film strip comprises a quantum dot phosphor layer and a transparent protective outer layer; wherein, the transparent protective outer layer encapsulates the quantum dot phosphor layer.

13. The liquid crystal display device as claimed in claim 12, wherein the quantum dot film strip further comprises a vapor isolation layer, which is provided between the transparent protective outer layer and the quantum dot phosphor layer.

14. The liquid crystal display device as claimed in claim 11, wherein it further comprises a condensing unit, which is provided between the quantum dot film strip and the light incident side.

15. The liquid crystal display device as claimed in claim 12, wherein it further comprises a condensing unit, which is provided between the quantum dot film strip and the light incident side.

16. The liquid crystal display device as claimed in claim 12, wherein it further comprises a condensing unit, which is provided on the outer side of the transparent protective outer layer.

17. The liquid crystal display device as claimed in claim 13, wherein it further comprises a condensing unit, which is provided on the outer side of the transparent protective outer layer.

18. The liquid crystal display device as claimed in claim 12, wherein the transparent protective outer layer is made of polyethylene terephthalate.

19. The liquid crystal display device as claimed in claim 11, wherein the quantum dot phosphor layer is formed by inkjet printing.

20. The liquid crystal display device as claimed in claim 12, wherein the vapor isolation layer is made of silicone.
